(19) United States
(12) Patent Application Publication
(10) Pub. No.: US 2009/0080781 A1
(43) Pub. Date: Mar. 26, 2009

(54) Pattern retrieval method and apparatus

(76) Inventor: Kazuhiro Tanabe, Kokaira-shi (JP)

Correspondence Address: BACON & THOMAS, PLLC, 625 SLATERS LANE, FOURTH FLOOR, ALEXANDRIA, VA, 22314-1176, US

(21) Appl. No.: 12/216,239

(22) Filed: Jul. 1, 2008

(30) Foreign Application Priority Data
Sep. 26, 2007 (JP) 2007-250202

(51) Int. Cl. G06K 9/62

(52) U.S. Cl. 382/209

(57) ABSTRACT

There is provided a pattern retrieval method for retrieving a reference pattern from a range to be retrieved, based on a correlation between image data in the range to be retrieved with the reference pattern indicated thereon and reference image data representing the reference pattern, wherein a plurality of characteristic lines less than the number of scanning lines are set in any one of a horizontal scanning direction and a vertical scanning direction of the reference image data. Then, the image data in the range to be retrieved is captured, a correlation value between the captured image data in the range to be retrieved and a pixel array on the set plurality of characteristic lines of the reference image data is calculated, and a position of the reference pattern in the range to be retrieved is detected based on the calculated correlation value.

### CROSS-REFERENCE TO RELATED APPLICATIONS

This application is based upon and claims the benefit of priority from prior Japanese Patent Application No. 2007-250202, filed Sep. 26, 2007, the entire contents of which are incorporated herein by reference.

### BACKGROUND OF THE INVENTION

1. Field of the Invention

The present invention relates to a pattern retrieval method and apparatus used for recognizing a position of an object to be manufactured in a manufacturing line, for example.

2. Description of the Related Art

In a procedure for manufacturing a semiconductor wafer, a liquid crystal panel, or the like, when a reference pattern, called an alignment mark or the like, indicated on an object to be manufactured is recognized, a pattern matching method is used. For example, as shown in Jpn. Pat. Appln. KOKAI Publication No. 11-143991, in the pattern matching method, a range to be retrieved is imaged by a camera to compare the image data with image data of a predetermined reference pattern in each pixel, whereby the reference pattern in the image data is detected based on the matching degree.

In the pattern matching method, a correlation operation is used for the comparison processing between the image data in the range to be retrieved and the image data of the reference pattern. As typical examples of the correlation operation, there are difference correlation and normalized correlation.

If the size of an image (template image) of the reference pattern is 256×256 (horizontal×vertical) pixels and the size of the image data obtained by imaging the range to be retrieved is 1628×1236 (horizontal×vertical) pixels (UXGA), a difference correlation value D is calculated by the following equation:

D=Σ|Fij−Gij|

where, i and j represent arbitral coordinates of a reference image (256×256 coordinates of the sum total is taken), Gij represents a brightness value of each pixel of a reference image block, and Fij represents a brightness value of each pixel of a comparison block of a screen to be retrieved.

Meanwhile, a normalized correlation value C is calculated by the following equation:

C=Y(Fij−Fav)×(Gij−Gav)/[√Σ(Fij−Fav)²×√Σ(Gij−Gav)²]

where, Gij represents a brightness value of each pixel of a reference image block, Fij represents a brightness value of each pixel of a comparison block of a screen to be retrieved, and Fav and Gav represent an average brightness of a block.

When the difference correlation value is used as the degree of correlation, and also when the normalized correlation value is used as the degree of correlation, a scanning operation that will be described below is required. FIG. 8 is a view for explaining the scanning operation.

First, a center position (x, y) of a reference pattern image (template image) is positioned at a pixel position (0, 0) in an image to be retrieved. In this state, the correlation value C_{0,0}, between the template image and a block of the image to be retrieved is calculated. In order to calculate the correlation value C_{0,0}, 256×256 clocks of the correlation operation processing is required. Second, the template image is shifted to the pixel position (1, 0) in the image to be retrieved to calculate the correlation value C_{1,0}. In the calculation of the correlation value C_{1,0}, 256×256 clocks of the correlation operation processing is required, as with the above-mentioned case. The template image is sequentially shifted until the center position (x, y) reaches the pixel position (1372, 980)=(1628−256, 1236−256) in the image to be retrieved, and the correlation value is calculated in each shift position. The highest correlation value of all the calculated correlation values C_{0,0} to C_{1372,980} is determined. The shift position at the time when the highest correlation value is obtained is determined as a position of the reference image in the image to be retrieved.

In the above scanning operation, the correlation operation should be performed at times corresponding to (1628−256)×(1236−256)×(256×256)=88,117,084,160 clocks. At this time, even when the processing speed of 1 clock is 162 MHz, 88,117,084,160×6.17 ns=544 seconds are required for the pattern retrieval. In the pattern retrieval using the matching processing between the template image and the image to be retrieved, since the correlation operation processing between the template image and the image to be retrieved is performed on all pixels in the range to be retrieved, a lot of time is required.

As a method for reducing the processing time of the pattern retrieval, there is a retrieval method using a pyramid approach. In this retrieval method, a thinning processing is first applied to the image data in the range to be retrieved at a high thinning rate. A first pattern retrieval is applied to the image data in which the image is thinned with the use of the template image. In the first pattern retrieval, plural positions of the image to be retrieved highly correlated to the template image are selected to be assumed to be candidates of positions to be retrieved. Second, the thinning processing is applied to these plural positions to be retrieved at a low thinning rate. A second pattern retrieval is applied to the image data at the position to be retrieved with the use of the template image. Then, the candidates are narrowed down based on the result of the second pattern retrieval. Subsequently, the thinning rate is further reduced to perform a third pattern retrieval, whereby a position having the highest correlation is detected.

In the pattern retrieval using the pyramid approach, the number of the correlation operations can be reduced in accordance with the thinning rate of an image, whereby a substantial time reduction can be realized, in comparison with the case in which the pattern retrieval is applied to all pixels.

However, in the pyramid approach, since the thinning processing is applied to the image to be retrieved, the high frequency component of the image is lost, like the case in which the image is passed through a low-pass filter, whereby edge information included in the image data to be retrieved may be lost. The edge information included in the original image data before being subjected to the thinning processing is important in the calculation of the correlation. In addition, the edge information is important in representing a shape of the entire image. Thus, the loss of the edge information causes erroneous determination, leading to the degradation of detection accuracy.

### BRIEF SUMMARY OF THE INVENTION

One aspect of the present invention provides a pattern retrieval method for retrieving a reference pattern from a range to be retrieved, based on correlation between image data in the range to be retrieved with the reference pattern indicated thereon and reference image data representing the reference pattern, wherein a plurality of characteristic lines less than the number of scanning lines are set in any one of a horizontal scanning direction and a vertical scanning direction of the reference image data. Then, the image data in the range to be retrieved is captured, a correlation value between the captured image data in the range to be retrieved and a pixel array on the set plurality of characteristic lines of the reference image data is calculated, and a position of the reference pattern in the range to be retrieved is detected based on the calculated correlation value.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an entire configuration of a pattern retrieval apparatus according to a first embodiment of the invention;

FIG. 2 is a block diagram showing a configuration of a control unit of the pattern retrieval apparatus shown in FIG. 1;

FIG. 3 is a view showing a circuit configuration of a difference correlation operational circuit of the control unit shown in FIG. 2;

FIG. 4 is a timing chart used for explaining the operation of the difference correlation operational circuit shown in FIG. 3;

FIG. 5 is a view for explaining a pattern retrieval operation by the control unit shown in FIG. 2;

FIG. 6 is a view for explaining an effect of the pattern retrieval operation by the control unit shown in FIG. 2;

FIG. 7 is a view for explaining an operation of a pattern retrieval apparatus according to another embodiment of the invention; and

FIG. 8 is a view for explaining a pattern retrieval operation using a pyramid approach.

### DETAILED DESCRIPTION OF THE INVENTION

Hereinafter, embodiments of the invention will be described with reference to the drawings.

### First Embodiment

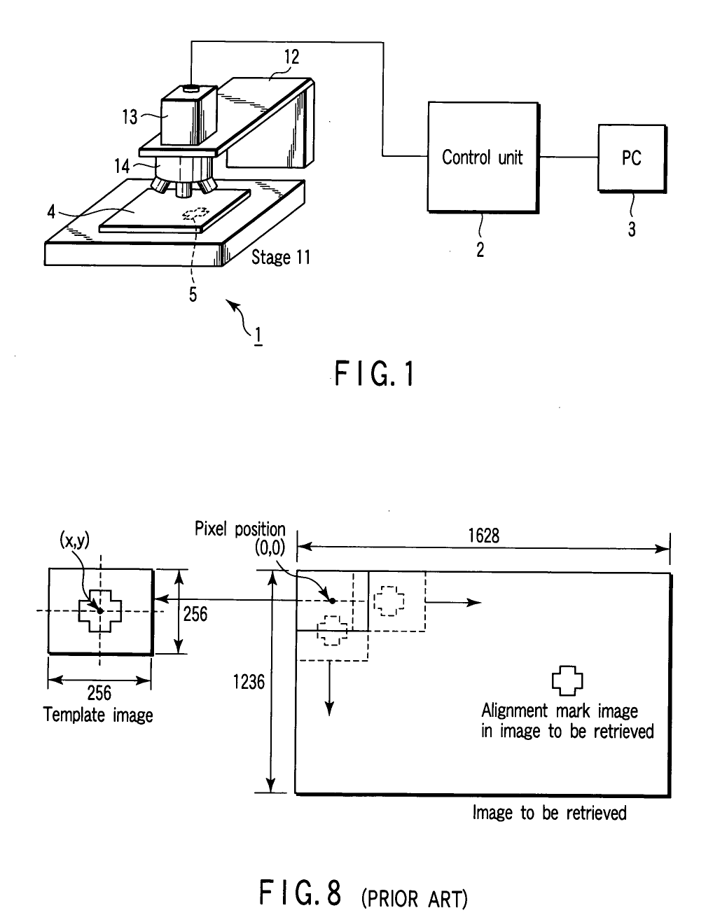

FIG. 1 is a schematic configuration diagram of a pattern retrieval apparatus according to a first embodiment of the invention. This pattern retrieval apparatus is provided with a mechanism part 1, a control unit 2, and a personal computer (PC) 3.

The mechanism part 1 is provided with a stage 11, a support member 12, a camera 13 and a microscope 14 which are attached to a top end of the support member 12. An electronic part 4 such as a semiconductor wafer and a LCD panel is placed on the stage 11. An alignment mark 5 is printed on the electronic part 4. The alignment mark 5 is used for recognition of the position of the electronic part 4, and formed in a cross pattern as shown in FIG. 1. The camera 13 is constituted of an industrial television camera, for example, and images the range to be retrieved, which includes the alignment mark 5 of the electronic part 4 on the stage 11 and is enlarged by the microscope 14, to output the image signal to the control unit 2.

The personal computer 3 is used for setting various control parameters, which are required for the pattern retrieval, to the control unit 2 in response to an input operation by an operator, and used for displaying a detection result of the position of the alignment mark 5 or electronic part 4 obtained by the control unit 2.

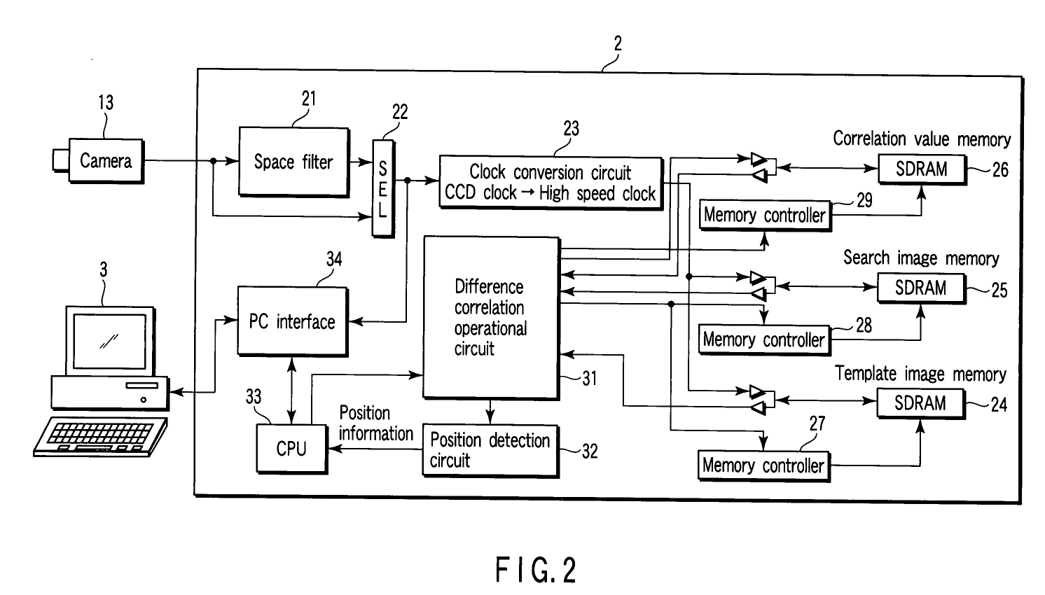

The control unit 2 executes the pattern retrieval processing of the alignment mark 5 indicated on the electronic part 4, and is configured as follows. FIG. 2 is a block diagram showing the configuration.

The control unit 2 is provided with a space filter 21, a selector (SEL) 22, and a clock conversion circuit 23. The space filter 21 performs the image processing for extracting the edge component of the image data which has been output from the camera 13 and converted into a digital signal by an analog/digital converter (not shown). The selector 22 alternatively outputs the image data with the extracted edge component or the image data before being input into the space filter 21. The clock conversion circuit 23 converts the clock speed of the image data which has been output from the selector 22 from the CCD clock speed of the camera 13 to a further higher clock speed.

Further, the control unit 2 is provided with a template image memory 24, a search image memory 25, a correlation value memory 26, and memory control circuits 27, 28, and 29 which control reading and writing of data from and into these memories 24, 25, and 26. The template image memory 24 is used for storing reference image (template image) data of the alignment mark 5 imaged by the camera 13. The search image memory 25 is used for storing image (search image) data in a range to be retrieved imaged by the camera 13. The correlation value memory 26 is used for storing an accumulated additional value of the correlation values calculated by a difference correlation operational circuit 31 to be described later.

Further, the control unit 2 is provided with the difference correlation operational circuit 31, a position detection circuit 32, a CPU 33, and a PC interface 34. The difference correlation operational circuit 31 has a function of setting plural characteristic lines (for example, 8 lines), which is less than the number of horizontal scanning lines (256 lines), to the template image stored in the template image memory 24. Further, the difference correlation operational circuit 31 has a circuit for calculating the correlation value between the template image and the search image. This calculation circuit calculates the correlation value between the line data of the characteristic line of the template image and one screen of the search image data in each characteristic line to cumulatively add the correlation value calculated in each characteristic line in a sequential manner.

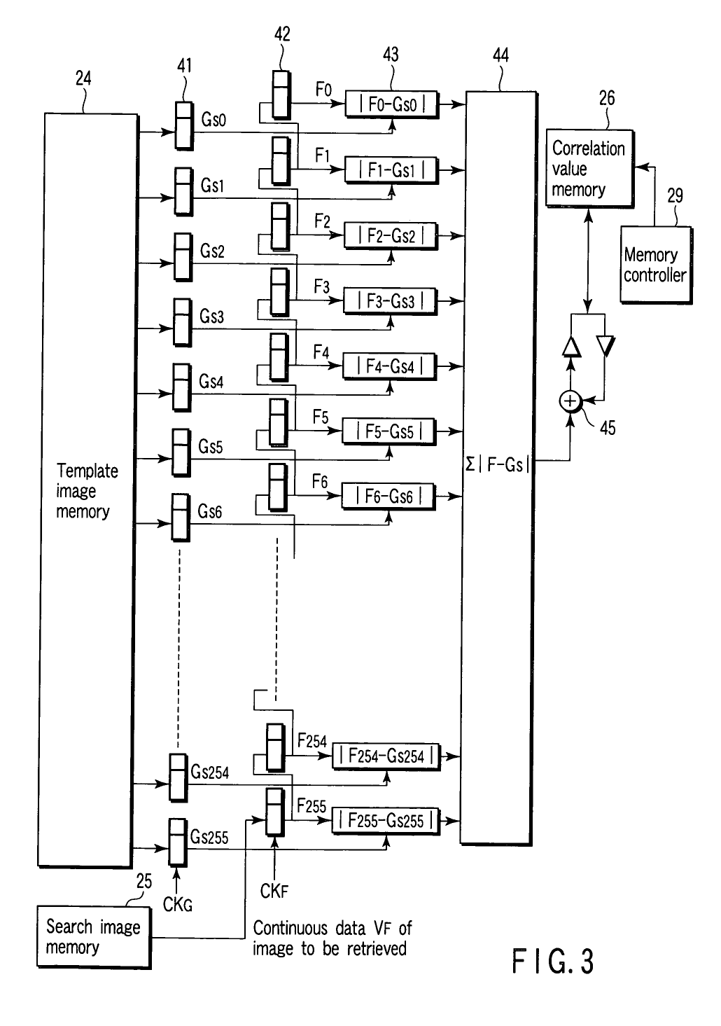

FIG. 3 shows an example of a configuration of a circuit for calculating the correlation value. The calculation circuit having a configuration in which one line data of the characteristic line is composed of 256 pixels is exemplified. The calculation circuit is composed of 256 pixels of a buffer 41 for holding the characteristic line data, 256 pixels of a shift register 42 for shifting the search image data, 256 pixels of a difference circuit 43, and an adder circuit 44.

The buffer 41 for holding the characteristic line data synchronizes one line (256 pixels) of the characteristic line data which has been read out from the template image memory 24 with a clock CKG to hold the characteristic line data, and thus to output one line of the characteristic line data Gs0 to Gs255 being held to the difference circuit 43. One screen of the search image data read out from the search image memory 25 is synchronized with a clock CKF to be sequentially shifted and input in series to the shift register 42. The shift register 42 shifts and outputs 256 pixels of the image data F0 to F255 in parallel at every shifting and inputting of one pixel.

The difference circuit 43 calculates, in each pixel, the difference correlation values |F0−Gs0| to |F255−Gs255| between 256 pixels of the search image data F0 to F255 output in parallel from the shift register 42 and one line (256 pixels) of the characteristic line data Gs0 to Gs255 output from the template image memory 24 at every shifting and inputting of one pixel of the search image data to the shift register 42. The difference circuit 43 outputs 256 pixels of the calculated difference correlation values |F0−Gs0| to |F255−Gs255| to the adder circuit 44.

The adder circuit 44 causes the correlation value memory 26 to store the difference correlation value between the first characteristic line data of the template image data and one screen of the search image data in a state as it is. When the difference correlation value between the second and subsequent characteristic line data of the template image data and the search image data is output from the difference circuit 43, the adder circuit 44 reads out the difference correlation value at the same pixel position from the correlation value memory 26 to add the above difference correlation value on the difference correlation value at the same pixel position, thereby causing the correlation value memory 26 to store the difference correlation value Σ|F−Gs|.

When the calculation processing of the difference correlation value between all the characteristic lines of the template image data and the search image data is terminated, the position detection circuit 32 reads out the accumulated correlation value D=Σ|F−Gs| of the difference correlation from the correlation value memory 26 to detect the position coordinates on the search image data having the highest accumulated correlation value D from the accumulated correlation value D=Σ|F−Gs|. The position detection circuit 32 then sends the information of the detected position coordinate to the CPU 33. The CPU 33 produces display data representing the pattern retrieval result on the basis of the position coordinate information from the position detection circuit 32 to transfer this display data to the personal computer 3 through the PC interface 34, and thus to display the display data.

Next, the operation of the pattern retrieval apparatus having the above constitution will be described.

(1) Registration of template image data and setting of characteristic line

An operator sets a sample electronic part, on which the alignment mark 5 is indicated by printing or marking, on the stage 11 to perform an operation of registering the template image in the personal computer 3 in this state.

Thereby, an instruction command for registering the template image is sent from the personal computer 3 to the control unit 2 to operate the microscope 14 and the camera 13 in response to this instruction command, and thus, to image the sample electronic part with the alignment mark 5 indicated thereon. In the image data of the sample electronic part, which is imaged by the camera 13 and includes the alignment mark 5, the edge component is extracted by the space filter 21, and the speed is converted by the clock conversion circuit 23, after which this image data as template image data VG is stored in the template image memory 24 under the control of the memory control circuit 27.

In the process of registering the template image data VG, the image data of the sample electronic part, which is imaged by the camera 13 and includes the alignment mark 5, and the image data of which edge component is extracted by the space filter 21 are alternatively switched by the selector 22 to be transferred from the PC interface 34 to the personal computer 3, and thus to be displayed. Thus, the operator can adjust the position of the sample electronic part and brightness while watching the displayed image.

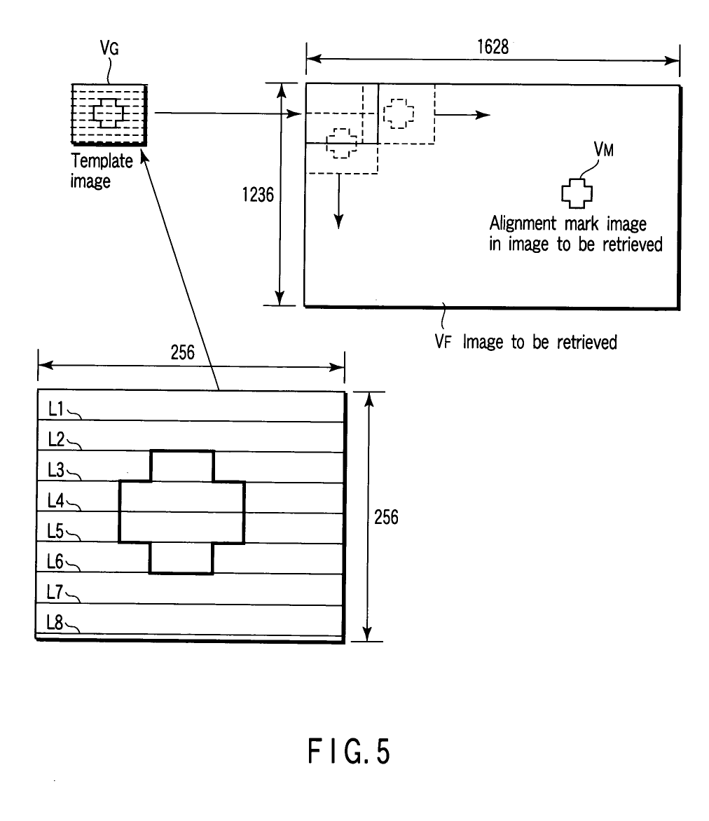

Then, the operator designates and inputs the number and position of the characteristic line on the personal computer 3, whereby information representing the input number and position of the characteristic line is sent from the personal computer 3 to the control unit 2 to be stored in a memory in the CPU 33. For instance, as shown in FIG. 5, eight characteristic lines, L1 to L8, are set to the template image data VG, and the positions of the characteristic lines L1 to L8 are set so that some of these characteristic lines intersect with an edge of an alignment mark image VM.

A predetermined initial value may be stored in the memory in the CPU 33 without setting the number and position of the characteristic lines L1 to L8 in each template image, so that the number and position of the characteristic lines L1 to L8 can be commonly used for assumed plural template image data VG.

(2) Pattern retrieval processing

When an operator inputs a pattern retrieval start sinstruction in the personal computer 3, a pattern retrieval start command is sent from the personal computer 3 to the control unit 2, whereby the pattern retrieval processing is started by the control unit 2.

Specifically, the alignment mark 5 is indicated on the electronic part 4 set on the stage 11, and the range to be retrieved including the alignment mark 5 is imaged by the camera 13 through the microscope 14. The edge component of the image data imaged by the camera 13 in the range to be retrieved is extracted by the space filter 21, and the speed is converted by the clock conversion circuit 23. Thereafter, this image data as search image data VF is stored in the search image memory 25 under the control of the memory control circuit 28.

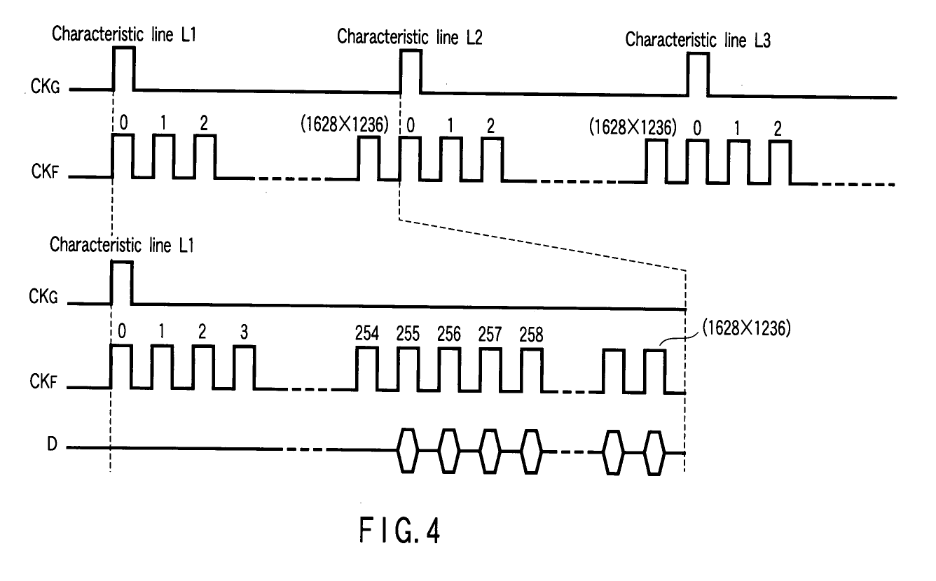

When the search image data VF is stored in the search image memory 25, the difference correlation operational circuit 31 performs the difference correlation operation processing between the template image data VG and the search image data VF under the control of the CPU 33. This difference correlation operation processing is shown as follows. FIG. 4 shows an operation timing of the difference correlation operational circuit 31.

Specifically, the image data (256 pixels) Gs0 to Gs255 on the characteristic line L1 of the template image data VG is first read out from the template image memory 24 under the control of the memory control circuit 27 to be synchronized with the clock CKG, and thus, held by the buffer 41.

In parallel with this, one screen of the search image data VF is sequentially and in series read out from the search image memory 25 under the control of the memory control circuit 28 to be synchronized with the clock CKG, and thus, shifted and input in series to the shift register 42. When 256 pixels of the search image data F0 to F255 are shifted and input to the shift register 42, the difference correlation value |F0−Gs0| to |F255−Gs255| between 256 pixels of the search image data F0 to F255 and the image data (256 pixels) Gs0 to Gs255 of the characteristic line L1 held by the buffer 41 is calculated by the difference circuit 43 to pass through the adder circuit 44, and thus, stored in the correlation value memory 26.

Subsequently, when the 257th pixel F256 of the search image data VF is shifted and input to the shift register 42, the difference correlation value |F1−Gs0| to |F256−Gs255| between the search image data F1 to F256 and the image data (256 pixels) Gs0 to Gs255 of the characteristic line L1 held by the buffer 41 is calculated by the difference circuit 43 to pass through the adder circuit 44, and thus, stored in the correlation value memory 26.

Likewise, each time the 256th and subsequent pixels (F257, F258, . . . ) of the search image data VF are shifted and input to the shift register 42, the difference correlation value between 256 pixels of the search image data input to the shift register 42 and the image data (256 pixels) of the characteristic line L1 held by the buffer 41 is calculated by the difference circuit 43 to be stored in the correlation value memory 26. As shown in FIG. 4, the (1628×1236)th pixel is input to the shift register 42, and the difference correlation value between 256 pixels of the search image data input to the shift register 42 at that time and the image data (256 pixels) of the characteristic line L1 held by the buffer 41 is stored in the correlation value memory 26, whereby the correlation operation processing between the characteristic line L1 and one screen of the search image data VF is terminated.

Then, the image data (256 pixels) Gs0 to Gs255 on the characteristic line L2 of the template image is read out from the template image memory 24 to be synchronized with the clock CKG, and thus, held by the buffer 41.

In parallel with this, as in the case of the characteristic line L1, one screen of the search image data VF is in series and sequentially read out from the search image memory 25 to be synchronized with the clock CKF, and thus, shifted and input in series to the shift register 42. When 256 pixels of the search image data F0 to F255 are shifted and input to the shift register 42, the difference correlation value |F0−Gs0| to |F255−Gs255| between 256 pixels of the search image data F0 to F255 and the image data (256 pixels) Gs0 to Gs255 on the characteristic line L2 held by the buffer 41 is calculated by the difference circuit 43.

At this time, the difference correlation value at the same position calculated in the case of the characteristic line L1 is read out from the correlation value memory 26 under the control of the memory control circuit 29. In the adder circuit 44, the difference correlation value |F0−Gs0| to |F255−Gs255| in the case of the characteristic line L2 which is calculated by the difference circuit 43 is added to the read-out difference correlation value |F0−Gs0| to |F255−Gs255| in the case of the characteristic line L1 by a pixel unit, and the difference correlation value after this addition is stored in the correlation value memory 26.

Likewise, each time the 256th and subsequent pixels (F257, F258, . . . ) of the search image data are shifted and input to the shift register 42, the difference correlation value between 256 pixels of the search image data input to the shift register 42 and the image data (256 pixels) of the characteristic line L2 held by the buffer 41 is calculated by the difference circuit 43. This calculated difference correlation value is added to the difference correlation value at the same position in the case of the characteristic line L1, which has been read out from the correlation value memory 26, by the adder circuit 44 to be stored in the correlation value memory 26.

Similarly, in each of the characteristic lines L3, L4, . . . , and L8, the difference correlation value between 256 pixels of the line data and one screen of the search image data VF is calculated. The calculated difference correlation value is sequentially added to the accumulated correlation value of the difference correlation obtained up to the previous characteristic line to be stored in the correlation value memory 26. Thus, the accumulated additional value D=Σ|F−Gs| of the difference correlation between the characteristic lines L1 to L8 and one screen of the search image data VF is finally stored in the correlation value memory 26.

For ease of explanation, the correlation value between the characteristic lines L1 to L8 and one screen of the search image data VF is calculated. However, since the correlation operation between the characteristic lines L1 to L8 and one screen of the search image data VF is performed in a block unit with the template image VG as one block as shown in FIG. 5, 128 pixels of each region on the left and right sides in one screen and 128 lines of each region on the upper and lower parts of the screen are not retrieved in this case.

As described above, when the accumulated additional value D=Σ|F−Gs| of the final difference correlation between the characteristic lines L1 to L8 and one screen of the search image data VF is calculated, the accumulated additional value D=Σ|F−Gs| of the final difference correlation is read out from the correlation value memory 26 under the control of the memory control circuit 29. Then, in the position detection circuit 32, a position coordinate in which the difference correlation value is maximum is detected from the accumulated additional value D=Σ|F−Gs| of the final difference correlation. Subsequently, in the CPU 33, display data representing the pattern retrieval result is produced based on the detected position coordinate to be sent to the personal computer 3 through the PC interface 34, and thus, displayed. The detection data of the position coordinate is used as an index for positioning in the processing process, assembly process, or test process of the electronic part 4.

As described above, in the first embodiment, the eight characteristic lines L1 to L8 less than the number of the horizontal scanning lines (256 lines) are set to the template image data VG stored in the template image memory 24. The difference correlation value between the line data of the characteristic lines L1 to L8 set to the template image data and one screen of the search image data VF is calculated for each of the characteristic lines L1 to L8 to sequentially and cumulatively add the difference correlation value |F−Gs| obtained for each of the characteristic lines L1 to L8 with the position coordinate of the image.

Thus, only the correlation operation processing between a pixel array on the eight characteristic lines L1 to L8 set to the template image data VG and the search image data VF in the range to be retrieved is performed. Therefore, the correlation operation processing can substantially reduce the extent of the correlation operation, to thereby reduce the time required for the pattern retrieval, in comparison with the case in which the correlation operation between all pixels of the template image data VG and all pixels of the search image data VF in the range to be retrieved is performed.

For instance, as shown in FIG. 5, when the size of the image data (search image data) in the range to be retrieved is 1628×1236 pixels, the size of the template image data is 256×256 pixels, and the number of the characteristic lines is eight, the number of clocks required for the correlation operation is (1628−256)×(1236−256)×8=10,756,480, whereby 10,756,480 clocks of the operational processing are required. Here, when the processing speed of one clock is 162 MHz, the time required for the pattern retrieval is 10,756,480×6.17 nsec=66 msec. Thus, a substantial time reduction can be realized in comparison with the conventional method.

Further, in the first embodiment, the correlation operation processing is performed without the thinning processing to the pixel array of 256 pixels on the characteristic lines L1 to L8 and the thinning processing on the search image data VF in the range to be retrieved. Therefore, the correlation operation processing can maintain high accuracy in the pattern retrieval, in comparison with the case in which to calculate the correlation between the pixel array on the characteristic lines L1 to L8 and the template image data VG after the thinning processing is applied to the search image data VF in the range to be retrieved at a uniform thinning rate in horizontal and vertical scanning directions.

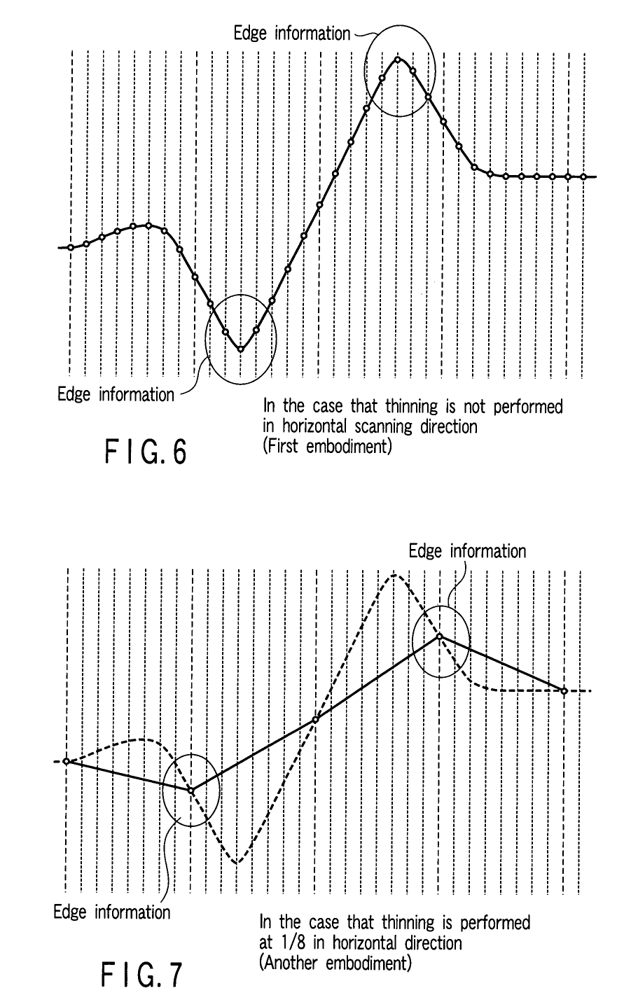

By way of example, in some cases, the width of the edge of the alignment mark 5 may become unrecognizable when the thinning processing is performed at a thinning rate exceeding 1/8. However, in the first embodiment, the thinning processing is not performed on the pixels in the horizontal scanning direction of the characteristic lines L1 to L8, whereby, as shown in FIG. 6, all the edge information of the alignment mark 5 can be detected.

Further, in the first embodiment, the difference correlation operational circuit 31 is composed of 256 pixels of the buffer 41 holding one line data of the characteristic lines L1 to L8 of the template image data VG, the shift register 42 to which one screen of the search image data is sequentially input and shifted in series, the difference circuit 43 calculating the difference correlation value between 256 pixels of the search image data output in parallel from the shift register 42 and one line (256 pixels) of the characteristic line data output from the template image memory 24 at every shifting and inputting of one pixel of the search image data to the shift register 42, and the adder circuit 44 sequentially and cumulatively adding the difference correlation value calculated by the difference circuit 43 in each of the characteristic lines L3, L4, . . . , and L8.

Accordingly, when one line data of the characteristic lines L1 to L8 is temporarily held by the buffer 41, the one line data is not required to be shifted, whereby the correlation operation processing is performed solely by shifting and inputting only the search image data VF to the shift register 42. Therefore, the correlation operation processing can be performed at a high speed by fewer processing procedures and by using small-sized hardware. In the conventional correlation operation method, the image data at the block position corresponding to the search image data should be scanned at every shifting by one pixel of the data block of the template image to perform the correlation operation, and therefore, it is unavoidable to increase the processing procedure, and at the same time, to increase the size of the circuit configuration.

### Another Embodiment

The first embodiment has described that the correlation operation between one line data of the characteristic lines L1 to L8 and the search image data VF is performed without applying the thinning processing to the one line data. However, the present invention is not limited to this case, and the thinning processing may be applied to one line data of the characteristic lines L to L8 if the thinning rate is lower than the rate required for the representation of the edge of the alignment mark 5. For instance, when one line data of the characteristic lines L1 to L8 is subjected to the thinning processing at a thinning rate of 1/8, although the resolution is lower than the case of not performing the thinning processing (see FIG. 6), the edge information can be detected as shown in FIG. 7.

The thinning processing is applied to one line data of the characteristic lines L1 to L8, whereby the minimum detectability of the edge is maintained, and at the same time, the number of the correlation operations is further reduced to realize a speed-up of the pattern retrieval processing.

As another method of setting the characteristic line, the following various methods are considered.

In the first method, when the number of the characteristic lines is eight, the template image data is equally divided into eight regions to integrate the edge component of the horizontal line in each of the eight regions. The horizontal line with the largest integration value is selected in each region to be set as the characteristic line.

In the second method, the template image data is equally divided into eight regions to obtain the largest edge component of the edge components in the vertical direction in each of the eight regions. The horizontal line positioned at a changing point (flexion point) of the edge is selected to be set as the characteristic line in the region.

In the third method, the template image data is equally divided into eight regions to select and set the horizontal line, which is positioned at the boundary with the adjacent region, as the characteristic line in each of the eight regions.

Further, in the first embodiment, a small number of the horizontal lines selected from the horizontal scanning lines are set as the characteristic line. However, the pixel arrays (for example, 8) less than the number of 256 pixel arrays in the vertical direction may be selected from the 256 pixel arrays to be set as the characteristic lines.

Further, the region where the alignment mark image exists is retrieved without equally setting the characteristic lines to the template image data, whereby the characteristic line may be set so as to intersect with the edge of the alignment mark only in the retrieved region. Additionally, although the difference correlation is used in the first embodiment, the normalized correlation may be used.

The configuration of the control unit, the circuit configuration of the difference correlation operational circuit, the size of the template image data and search image data, the setting number of the characteristic lines, the shape of the alignment mark, the usage of the pattern retrieval result, and so on can be variously modified and embodied without departing from the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern retrieval method for retrieving a reference pattern from a range to be retrieved, based on correlation between image data in the range to be retrieved with the reference pattern indicated thereon and reference image data representing the reference pattern, the method comprising:
setting a plurality of characteristic lines less than the number of scanning lines in any one of a horizontal scanning direction and a vertical scanning direction of the reference image data;
capturing the image data in the range to be retrieved;
calculating a correlation value between the captured image data in the range to be retrieved and a pixel array on the plurality of characteristic lines of the reference image data; and
detecting a position of the reference pattern in the range to be retrieved, based on the correlation value.

2. The method according to claim 1, wherein calculating the correlation value further comprises thinning the pixel array on the plurality of characteristic lines at a thinning rate lower than the rate required for the representation of an edge of the reference pattern, to thereby calculate the correlation value between the captured image data in the range to be retrieved and the thinned pixel array on the characteristic line.

3. The method according to claim 1, wherein calculating the correlation value further comprises calculating in each of the plurality of characteristic lines, the correlation value between the pixel array on the plurality of characteristic lines and the captured image data in the range to be retrieved to cumulatively add the correlation value calculated for each of the characteristic lines.

4. The method according to claim 1, wherein at least one of the plurality of characteristic lines is a scanning line including an edge component of the reference pattern of the reference image data.

5. The method according to claim 1, wherein the correlation value is any of a difference correlation value and a normalized correlation value.

6. A pattern retrieval apparatus which retrieves a reference pattern from a range to be retrieved, based on correlation between image data in the range to be retrieved with the reference pattern indicated thereon and reference image data representing the reference pattern, the apparatus comprising:
a setting unit which sets a plurality of characteristic lines less than the number of scanning lines in any one of a horizontal scanning direction and a vertical scanning direction of the reference image data;
a capturing unit which captures the image data in the range to be retrieved from a camera;
a calculating unit which reads out a pixel array on the plurality of characteristic lines of the reference image data from a memory to calculate a correlation value between the image data in the range to be retrieved captured from the camera and the pixel array on the read-out characteristic lines; and
a detecting unit which detects a position of the reference pattern in the range to be retrieved, based on the calculated correlation value.

7. The apparatus according to claim 6, wherein the calculating unit further comprises thinning the pixel array on the plurality of characteristic lines at a thinning rate lower than the rate required for the representation of an edge of the reference pattern, to thereby calculate the correlation value between the captured image data in the range to be retrieved and the thinned pixel array on the characteristic line.

8. The apparatus according to claim 6, wherein the calculating unit calculates, in each of the plurality of characteristic lines, the correlation value between the pixel array on the plurality of characteristic lines and the captured image data in the range to be retrieved to cumulatively add the correlation value calculated for each of the characteristic lines.

9. The apparatus according to claim 6, wherein at least one of the plurality of characteristic lines is a scanning line including an edge component of the reference pattern of the reference image data.

10. The apparatus according to claim 6, wherein the correlation value is any of a difference correlation value and a normalized correlation value.
